(19) United States
(12) Patent Application Publication
(10) Pub. No.: US 2011/0101582 A1
(43) Pub. Date: May 5, 2011

(54) FLUID-FILLED ACTIVE ENGINE MOUNT

(75) Inventor: Tomohiro KANAYA, Kasugai-shi (JP)

(73) Assignee: TOKAI RUBBER INDUSTRIES, LTD., Aichi-ken (JP)

(21) Appl. No.: 12/894,537

(22) Filed: Sep. 30, 2010

(30) Foreign Application Priority Data
Oct. 30, 2009 (JP) 2009-251083

(51) Int. Cl. F16F 13/26; F16F 13/08

(52) U.S. Cl. 267/140.14

(57) ABSTRACT

In an active fluid-filled engine mount, a oscillation member is excited and displaced by an electromagnetic actuator, and thereby pressure in a pressure receiving chamber is actively controlled. A short circuit passage is provided connecting the pressure receiving chamber and an equilibrium chamber. A ratio of a passage cross-sectional area and a passage length of the short circuit passage (a/l) is provided greater than a ratio of a passage cross-sectional area and a passage length of the first orifice passage (A/L) (A/L<a/l). The passage cross-sectional area of the short circuit passage (a) is provided smaller than the passage cross-sectional area of the first orifice passage (A) (a<A).

### CROSS-REFERENCE TO RELATED APPLICATIONS

The present application claims priority under 35 U.S.C. §119 of Japanese Application No. 2009-251083, filed on Oct. 30, 2009, which is herein expressly incorporated by reference in its entirety.

### BACKGROUND OF THE INVENTION

1. Field of the Invention

The present invention relates to a fluid-filled engine mount suitably employed as a vehicle engine mount, for instance. Specifically, the present invention relates to a fluid-filled active engine mount that actively controls pressure in a pressure receiving chamber, and thus achieves a balancing-out anti-vibration effect.

2. Description of Related Art

A fluid-filled active engine mount is conventionally known as one type of an anti-vibration apparatus provided between members included in a vibration transmission system so as to mutually isolate vibration and connect the members. The fluid-filled active engine mount is provided with a pressure receiving chamber and an equilibrium chamber filled with incompressible fluid, and an orifice passage mutually connecting the pressure receiving chamber and the equilibrium chamber. Further, pressure in the pressure receiving chamber can actively be controlled by an electromagnetic actuator. For instance, Related Art 1 (Japanese Patent Publication No. 4020087) discloses such an apparatus.

In the fluid-filled active engine mount as described above, the orifice passage is generally tuned to a low frequency range. In a frequency range higher than the range, the electromagnetic actuator controls pressure in the pressure receiving chamber. Thereby, a passive anti-vibration effect is exercised in the low frequency range, based on a high damping effect of a first orifice passage; and an active anti-vibration effect is exercised in the middle to high frequency range based on vibration isolation, since low dynamic spring performance is attained as the pressure of the pressure receiving chamber is controlled by the electromagnetic actuator.

In the fluid-filled active engine mount having the conventional structure, however, it is difficult to attain a sufficient low dynamic spring performance based on the pressure control by the electromagnetic actuator, in the middle frequency range proximate to the frequency to which the orifice passage is tuned. Thus, a required active anti-vibration effect may not be attained sufficiently.

Especially with a high demand for fuel performance, an engine speed when a vehicle is stopped tends to be low recently. An idling vibration frequency then shifts to the low frequency side, and is more proximate to an engine shake frequency, to which the orifice passage is tuned. A new technology is thus required to sufficiently and stably achieve the active anti-vibration effect based on the pressure control of the pressure receiving chamber by the electromagnetic actuator, even in the middle frequency range close to the frequency to which the orifice passage is tuned.
[Related Art 1] Japanese Patent Publication No. 4020087

### SUMMARY OF THE INVENTION

In view of the above, the present invention provides a fluid-filled active engine mount having a novel structure capable of sufficiently and stably achieving an anti-vibration effect on vibration in a middle to high frequency close to a frequency to which an orifice passage is tuned, the anti-vibration effect being attained by a low dynamic spring performance based on pressure control of a pressure receiving chamber, while maintaining a passive anti-vibration effect on a low frequency range by the orifice passage.

A first aspect of the present invention provides a fluid-filled active engine mount including a pressure receiving chamber having a wall portion partially formed of a main rubber elastic body connecting a first mounting member and a second mounting member; and an equilibrium chamber having a wall portion partially formed of a flexible diaphragm. Incompressible fluid is filled in the pressure receiving chamber and the equilibrium chamber. A first orifice passage is provided mutually connecting the pressure receiving chamber and the equilibrium chamber. The first orifice passage is tuned to a low frequency corresponding to an engine shake. An oscillation member is provided exerting an oscillation force to the pressure receiving chamber. An electromagnetic actuator is provided exerting a driving force on the oscillation member. The oscillation member is excited and displaced by the electromagnetic actuator, and thereby a pressure in the pressure receiving chamber is actively controlled. A short circuit passage is provided connecting the pressure receiving chamber to the equilibrium chamber. A ratio of a passage cross-sectional area and a passage length of the short circuit passage is provided greater than a ratio of a passage cross-sectional area and a passage length of the first orifice passage. The passage cross-sectional area of the short circuit passage is provided smaller than the passage cross-sectional area of the first orifice passage.

In the fluid-filled active engine mount having a structure according to the first aspect, as also demonstrated in experimental data of an embodiment hereinafter described, excellent anti-vibration performance is exhibited based on a low dynamic spring effect utilizing the oscillation force exerted by the electromagnetic actuator, even in a middle frequency range proximate to the frequency range to which the first orifice passage is tuned, the first orifice passage being tuned to a low frequency range.

In addition, a transfer level of the oscillation force by the electromagnetic actuator is substantially constant even in the middle frequency range proximate to the frequency range to which the first orifice passage is tuned, and thus a sudden property change due to a frequency change can be prevented. Accordingly, an intended active anti-vibration effect can stably be achieved also in the middle frequency range proximate to the frequency range to which the first orifice passage is tuned.

A second aspect of the present invention provides the fluid-filled active engine mount according to the first aspect, further including a excitation chamber having a wall portion partially formed of the oscillation member. Incompressible fluid is filled in the vibration chamber. A second orifice passage is provided connecting the excitation chamber to the pressure receiving chamber. The second orifice passage is tuned to an idling vibration at a higher frequency than that in the first orifice passage.

According to the second aspect, the anti-vibration effect is achieved based on resonance and the like of the fluid flowing through the second orifice passage. A through-hole connecting the pressure receiving chamber and the excitation chamber may be provided to the wall portion separating the pressure receiving chamber and the excitation chamber, separately from the second orifice passage. In this case, it is preferable that a movable member be provided switching the through-hole between a connected state and a blocked state.

A third aspect of the present invention provides the fluid-filled active engine mount according to the first or second aspects, wherein the short circuit passage comprises a short circuit hole penetrating a portion of the wall portion of the first orifice passage; and the pressure receiving chamber is connected to the equilibrium chamber through the first orifice passage.

The first orifice passage connecting the pressure receiving chamber and the equilibrium chamber is short-circuited in an intermediate portion in a passage length direction as described in the third aspect, and thereby a high dynamic spring property due to anti-resonance of the first orifice passage can be prevented. Further, the short circuit passage is provided utilizing a portion of the first orifice passage, and thus the short circuit passage has a high degree of freedom in the passage length.

A fourth aspect of the present invention provides the fluid-filled active engine mount according to the third aspect, wherein the short circuit hole is provided connecting the pressure receiving chamber and the first orifice passage and is provided at a same circumferential position as an opening portion of the first orifice passage on the equilibrium chamber side.

According to the fourth aspect, the short circuit hole is provided connecting the pressure receiving chamber and an end portion of the first orifice passage on the equilibrium chamber side, and thereby the passage length of the short circuit passage is provided shorter than the passage length of the first orifice passage. Thus, it is easy to set the ratio of the passage cross-sectional area and the passage length of the short circuit passage within a range of A/L<a/l.

A fifth aspect of the present invention provides the fluid-filled active engine mount according to the third or fourth aspect, wherein the short circuit hole is provided extending in an orthogonal direction to a passage length direction of the first orifice passage.

According to the fifth aspect, the fluid flow direction through the first orifice passage is orthogonal to the fluid flow direction through the short circuit hole. Thus, a fluid flow amount in the first orifice passage can be prevented from being reduced due to a leak through the short circuit hole, and thereby the anti-vibration effect by the first orifice passage can effectively be exerted.

According to the present invention, the pressure receiving chamber and the equilibrium chamber are connected by the short circuit passage, and thereby the vibration isolation effect due to low dynamic spring performance is exerted in a frequency range in which the first orifice passage is substantially blocked. Particularly, providing the short circuit passage to the active fluid-filled engine mount stably achieves the anti-vibration effect attained by active control of pressure in the pressure receiving chamber, even when an input vibration frequency varies.

Further, the passage cross-sectional area (a) and the passage length (l) of the short circuit passage are set relative to the passage cross-sectional area (A) and the passage length (L) of the first orifice passage, such that A/L<a/l and a<A are met. Thus, the liquid pressure can be prevented from being transferred through the short circuit passage in an unnecessarily large amount, and the anti-vibration effect of the first orifice passage can effectively be achieved. In addition, the oscillation force exerted to the pressure receiving chamber can be prevented from being transferred to the equilibrium chamber through the short circuit passage, and thus the active anti-vibration effect can efficiently be achieved.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a vertical cross-sectional view illustrating an engine mount according to an embodiment of the present invention;

FIG. 2 is a cross-sectional view of the engine mount along II-II in FIG. 1;

FIG. 3 is a graph illustrating a dynamic spring property of the engine mount shown in FIG. 1 when a small amplitude vibration is input;

FIG. 4 is a graph illustrating vibration isolation performance of the engine mount shown in FIG. 1; and

FIG. 5 is a graph illustrating a damping property of the engine mount shown in FIG. 1 when a large amplitude vibration is input;

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The embodiments of the present invention are explained below with reference to the drawings.

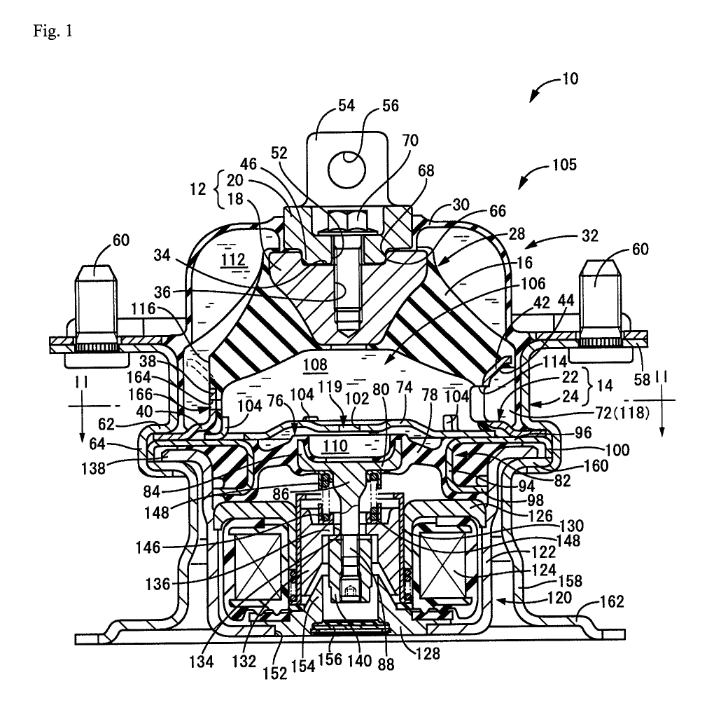

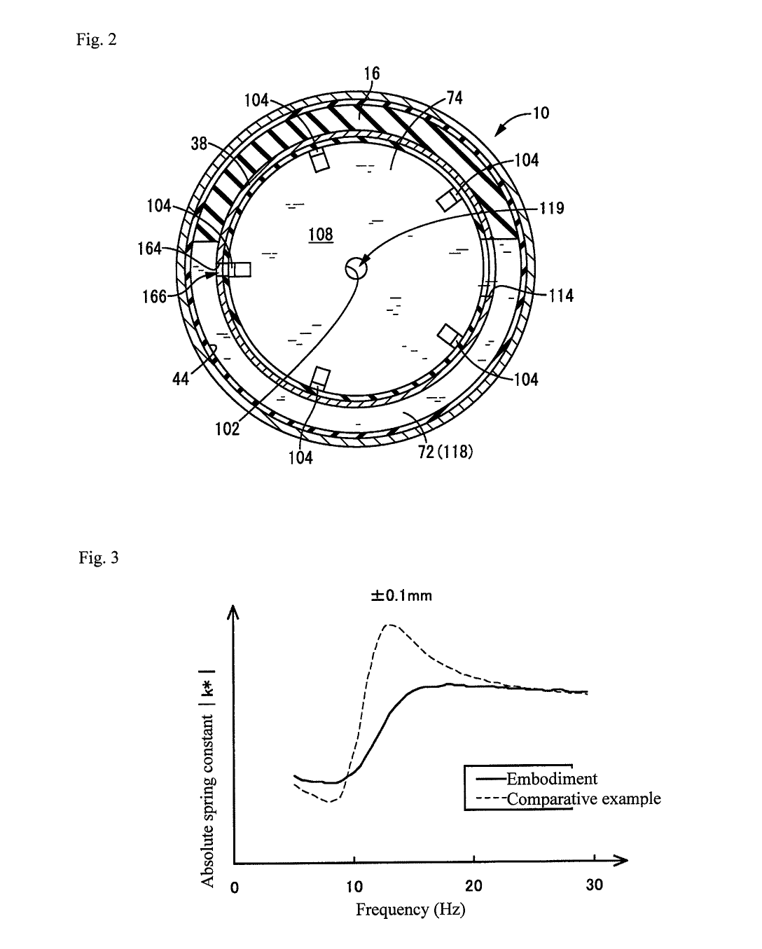

An engine mount 10 for a vehicle is first shown in FIGS. 1 and 2, as an embodiment of the present invention relating to a fluid-filled active engine mount. The engine mount 10 has a structure in which a first mounting member 12 and a second mounting member 14 are elastically connected by a main rubber elastic body 16. The first mounting member 12 is attached to a power unit of a vehicle; and the second mounting member 14 is attached to a vehicle body (not shown in the drawings). Thereby, the engine mount 10 provides vibration isolation to and supports the power unit against the body. In the mount state, a shared load of the power unit and main vibration to be isolated are input between the first mounting member 12 and the second mounting member 14 in substantially an axial direction (vertical direction of FIG. 1) of the engine mount 10. In the explanation below, a vertical direction principally refers to the vertical direction of FIG. 1.

Specifically, the first mounting member 12 has a main rubber inner fitting 18 and a flexible diaphragm inner fitting 20. The second mounting member 14 has a main rubber outer tubular fitting 22 and a flexible diaphragm outer tubular fitting 24. The main rubber inner fitting 18 and the main rubber outer tubular fitting 22 are vulcanized and adhered to the main rubber elastic body 16, and thereby a first integrated vulcanized molding 28 is provided. The flexible diaphragm inner fitting 20 and the flexible diaphragm outer tubular fitting 24 are vulcanized and adhered to a flexible diaphragm 30, and thereby a second integrated vulcanized molding 32 is provided. The first integrated vulcanized molding 28 and the second integrated vulcanized molding 32 are mutually combined.

The main rubber inner fitting 18 included in the first integrated vulcanized molding 28 has substantially an inverted circular truncated conical shape. Further, the main rubber inner fitting 18 is provided with a fitting recess 34 to an upper end surface (end surface on a large diameter side). A screw hole 36 is provided open to a bottom surface of the fitting recess 34.

In addition, the main rubber outer tubular fitting 22 has a tubular wall portion 38 having substantially a large diameter tubular shape. A flange-shaped portion 40 is integrally provided to an axially lower end portion of the tubular wall portion 38, the flange-shaped portion 40 widening externally in a diameter direction. A tapered tubular portion 42 is provided to an axially upper end portion of the tubular wall portion 38, the tapered tubular portion 42 gradually widening axially upward. A peripheral groove 44 is thus provided on an external peripheral side of the main rubber outer tubular fitting 22, the peripheral groove 44 being open to an external peripheral surface and extending in a circumferential direction for a less than a circle length. The main rubber inner fitting 18 is provided above the main rubber outer tubular fitting 22 separately therefrom on substantially the same central axis. An external peripheral surface having an inverted tapered shape of the main rubber inner fitting 18 and an internal peripheral surface of the tapered tubular portion 42 of the main rubber outer tubular fitting 22 are provided separately facing each other. The facing surfaces of the main rubber inner fitting 18 and the main rubber outer tubular fitting 22 are elastically connected.

The main rubber elastic body 16 has a large-diameter circular truncated conical shape as a whole. The main rubber inner fitting 18 is provided concentrically and vulcanized and adhered to a middle portion of the main rubber elastic body 16. The tapered tubular portion 42 of the main rubber outer tubular fitting 22 is placed over an external peripheral surface of an end portion on a large diameter side, and vulcanized and adhered thereto. Thereby, the main rubber elastic body 16 is provided as the first integrated vulcanized molding 28 having the main rubber inner fitting 18 and the main rubber outer tubular fitting 22, as described above.

The flexible diaphragm inner fitting 20 included in the second integrated vulcanized molding 32 has a thick circular shape. A fitting projection 46 is provided to a lower surface of the flexible diaphragm inner fitting 20. A through-hole 52 is provided penetrating a portion to which the fitting projection 46 is provided. Further, a mounting plate portion 54 projecting upward is integrally provided to the flexible diaphragm inner fitting 20. A bolt through-hole 56 is provided to a middle portion of the mounting plate portion 54.

The flexible diaphragm outer tubular fitting 24 has a large-diameter thin tubular shape. A plate portion for mounting 58 is integrally provided to an opening portion on an axially upper side of the flexible diaphragm outer tubular fitting 24, the plate portion for mounting 58 widening externally in the diameter direction. A plurality of fixing bolts 60 are provided to the plate portion for mounting 58. Further, a flange-shaped portion 62 is integrally provided to an opening portion on an axially lower side of the flexible diaphragm outer tubular fitting 24, the flange-shaped portion 62 having an annular plate shape and widening externally in the diameter direction. Furthermore, a crimping piece 64 is integrally provided to an external peripheral portion of the flange-shaped portion 62, the crimping piece 64 having an annular shape and projecting axially downward.

The flexible diaphragm inner fitting 20 is provided axially above the flexible diaphragm outer tubular fitting 24 separately therefrom on substantially the same central axis. The flexible diaphragm inner fitting 20 and the flexible diaphragm outer tubular fitting 24 are connected by the flexible diaphragm 30.

The flexible diaphragm 30, which is formed of a thin rubber diaphragm, has a cross-sectionally curved shape having a large looseness allowing easy elastic deformation, and substantially an annular shape extending in the circumferential direction. An internal peripheral portion of the flexible diaphragm 30 is vulcanized and adhered to an external peripheral portion of the flexible diaphragm inner fitting 20. An external peripheral portion of the flexible diaphragm 30 is vulcanized and adhered to an opening portion on the axially upper side of the flexible diaphragm outer tubular fitting 24. Thereby, the flexible diaphragm 30 is provided as the second integrated vulcanized molding 32 having the flexible diaphragm inner fitting 20 and the flexible diaphragm outer tubular fitting 24, as described above.

The second integrated vulcanized molding 32 is thus placed over the above-described first integrated vulcanized molding 28 from above and assembled thereto. The flexible diaphragm inner fitting 20 is fixedly attached to the main rubber inner fitting 18, and the flexible diaphragm outer tubular fitting 24 is fixedly attached to the main rubber outer tubular fitting 22. Further, the flexible diaphragm 30 is provided external to and separately from the main rubber elastic body 16, such that the flexible diaphragm 30 entirely covers an external peripheral surface of the main rubber elastic body 16.

Specifically, the flexible diaphragm inner fitting 20 is directly placed over an upper surface of the main rubber inner fitting 18. The fitting projection 46 of the flexible diaphragm inner fitting 20 is fitted to the fitting recess 34 of the main rubber inner fitting 18, and thereby the flexible diaphragm inner fitting 20 and the main rubber inner fitting 18 are positioned on the same central axis. In the present embodiment in particular, an engagement function of a cut-out engagement external peripheral surface 66 and an engagement internal peripheral surface 68, which are provided to external peripheral surfaces of the fitting projection 46 and the fitting recess 34, respectively, allows mutual positioning of the flexible diaphragm inner fitting 20 and the main rubber inner fitting 18 in the circumferential direction as well. Thus, the through-hole 52 of the flexible diaphragm inner fitting 20 and the screw hole 36 of the main rubber inner fitting 18 are positioned.

As shown in FIG. 1, in a state in which the main rubber inner fitting 18 and the flexible diaphragm inner fitting 20 are placed together, a joint bolt 70 is screwed to the screw hole 36 of the main rubber inner fitting 18 through the through-hole 52 of the flexible diaphragm inner fitting 20. Thus, the main rubber inner fitting 18 and the flexible diaphragm inner fitting 20 are jointly fixed by the joint bolt 70, and thereby the first mounting member 12 is provided.

Meanwhile, the flexible diaphragm outer tubular fitting 24 is inserted to the main rubber outer tubular fitting 22 externally from axially above. In a lower end portion of the main rubber outer tubular fitting 22, an external peripheral portion of the flange-shaped portion 40 is axially placed over the flange-shaped portion 62 of the flexible diaphragm outer tubular fitting 24. In an upper end portion thereof, an open end edge portion of the tapered tubular portion 42 is radially placed over an internal peripheral surface of the diaphragm outer tubular fitting 24.

The crimping piece 64 of the diaphragm outer tubular fitting 24 is crimped and fixed to the external peripheral portion of the flange-shaped portion 40 of the main rubber outer tubular fitting 22. Thus, the main rubber outer tubular fitting 22 and the diaphragm outer tubular fitting 24 are mutually fixed and assembled. A seal rubber is provided to each of upper and lower end portions of the main rubber outer tubular fitting 22 over which the diaphragm outer tubular fitting 24 is placed, the seal rubber being integrally provided with the main rubber elastic body 16 or the flexible diaphragm 30. The portions are fluid-tightly sealed. Thereby, the peripheral groove 44 provided to the main rubber outer tubular fitting 22 is fluid-tightly covered by the diaphragm outer tubular fitting 24. An annular passage 72 is thus provided between radially opposing surfaces of the tubular wall portion 38 of the main rubber outer tubular fitting 22 and the diaphragm outer tubular fitting 24, the annular passage 72 being provided in the circumferential direction and continuously extending for a predetermined length or along an entire periphery.

Further, a partition plate fitting 74 and a support member 76 are assembled to a lower side opening portion of the main rubber outer tubular fitting 22. An oscillation member 80 is vulcanized and adhered to a middle portion of a support rubber elastic body 78 having substantially an annular shape of the support member 76. An annular holding fitting 82 is vulcanized and adhered to an external peripheral portion of the support rubber elastic body 78. The oscillation member 80 and the annular holding fitting 82 are elastically connected by the support rubber elastic body 78.

The oscillation member 80 having a circulate plate shape is integrally provided with an annular joint portion 84 projecting upward from an external peripheral portion. A driving axis 86 extending downward is integrally provided to a middle portion of the oscillation member 80. An end portion of the driving axis 86 (lower side of FIG. 1) is a male thread portion 88, on which a screw groove is carved.

Meanwhile, the annular holding fitting 82 is integrally provided with a mounting plate portion 96 and a positioning projection 98, each of which widens in a flange-shape, to upper and lower opening portions, respectively, of a tubular portion 94. An annular press-fit portion 100 projecting further downward is integrally provided to an external peripheral portion of the mounting plate portion 96.

The oscillation member 80 is provided radially internal to and separately from the annular holing fitting 82 on substantially the same central axis. The support rubber elastic body 78 is provided spreading out between radially opposing surfaces of the annular holing fitting 82 and the oscillation member 80. An internal peripheral portion and an external peripheral portion of the support rubber elastic body 78 are vulcanized and adhered to an opposing surface of the annular joint portion 84 of the oscillation member 80 and the tubular portion 94 of the annular holding fitting 82, respectively. The oscillation member 80 and the annular holding fitting 82 are fluid-tightly closed by the support rubber elastic body 78.

The partition plate fitting 74 has a thin circular plate shape and an external diameter reaching a radially intermediate portion of the mounting plate portion 96 of the annular holding fitting 82. A middle portion of the partition plate fitting 74 has a plateau shape projecting upward. An orifice through-hole 102 is provided on the central axis of the partition plate fitting 74. Further, a plurality of engagement pieces 104 are provided projecting upward on a circumference proximate to the external peripheral portion of the partition plate fitting 74.

The partition plate fitting 74 is positioned in an orthogonal direction to the axis by the engagement pieces 104. In a lower side opening portion of the flexible diaphragm outer tubular fitting 24, the external peripheral portion is placed over and assembled to the flange-shaped portion 40 of the main rubber outer tubular fitting 22, which is assembled to the flexible diaphragm outer tubular fitting 24. Further, the support member 76 is assembled to the lower side opening portion of the flexible diaphragm outer tubular fitting 24, from below the partition plate fitting 74. The mounting plate portion 96 of the annular holding fitting 82 in the support member 76 is placed over the main rubber outer tubular fitting 22 and the partition plate fitting 74. External peripheral portions of the main rubber outer tubular fitting 22 and the partition plate fitting 74 are crimped and fixed by the crimping piece 64. Thus, the first integrated vulcanized molding 28, the second integrated vulcanized molding 32, the partition plate fitting 74, and the support member 76 constitute a mount main body 105.

Thereby, the lower side opening portion of the flexible diaphragm outer tubular fitting 24 is fluid-tightly covered by the support member 76, and thus a main liquid chamber 106 filled with incompressible fluid is provided between opposing surfaces of the main rubber elastic body 16 and the support member 76.

Further, the main liquid chamber 106 is provided with the partition plate fitting 74, at which the main liquid chamber 106 is halved into a pressure receiving chamber 108 on the main rubber elastic body 16 side and an excitation chamber 110 on the support member 76 side. When vibration is input between the first mounting member 12 and the second mounting member 14, pressure fluctuation is generated in the pressure receiving chamber 108 having a wall portion partially formed by the main rubber elastic body 16, since vibration is input based on elastic deformation of the main rubber elastic body 16. Meanwhile, an oscillation force is exerted to the excitation chamber 110 having a wall portion partially formed by the oscillation member 80, due to reciprocal displacement of the oscillation member 80 initiated by an electromagnetic actuator 120 hereinafter described.

Further, the internal peripheral portion of the main rubber elastic body 16 and the external peripheral portion of the flexible diaphragm 30 are fixedly attached to the first attachment portion 12 and the second attachment portion 14, respectively. Thus, an equilibrium chamber 112 filled with incompressible fluid is provided between opposing surfaces of the main rubber elastic body 16 and the flexible diaphragm 30. Specifically, the equilibrium chamber 112 has a wall portion partially formed by the easily deformable flexible diaphragm 30, and thus volumetric change is easily tolerated based on elastic deformation of the flexible diaphragm 30. As the incompressible fluid filled in the main liquid chamber 106 and the equilibrium chamber 112, a low-viscosity fluid having a viscosity of 0.1 Pa·s or less is preferably employed in general, in order to effectively achieve an anti-vibration effect in a vibration frequency range required for the engine mount 10 for a vehicle, the anti-vibration effect being provided based on resonance of the fluid flowing through a first orifice passage 118 hereinafter described.

Further, the annular passage 72 is provided utilizing the second mounting member 14. A first end portion of the annular passage 72 in the circumferential direction is connected to the pressure receiving chamber 108 through a first connecting hole 114. A second end portion of the annular passage 72 in the circumferential direction is connected to the equilibrium chamber 112 through a second connecting hole 116 provided to the main rubber elastic body 16. Thereby, the first orifice passage 118 is provided for a predetermined length around the pressure receiving chamber 108, the first orifice passage 118 mutually connecting the pressure receiving chamber 108 and the equilibrium chamber 112 and allowing fluid flow between the pressure receiving chamber 108 and the equilibrium chamber 112. A passage cross-sectional area and a passage length of the first orifice passage 118 are set and tuned appropriately, such that the anti-vibration effect based on the resonance of the fluid flowing inside is effectively exerted in a low frequency range of approximately 10 Hz corresponding to an engine shake, based on a pressure difference generated between the pressure receiving chamber 108 and the equilibrium chamber 118 at the time of vibration input.

Furthermore, a second orifice passage 119 is provided by the orifice through-hole 102 provided to the partition plate fitting 74, the second orifice passage 119 mutually connecting the pressure receiving chamber 108 and the excitation chamber 110. The second orifice passage 119 is tuned to a higher frequency range than the first orifice passage 118, such that the anti-vibration effect based on the fluid flow effect is effectively exerted in a middle frequency range of approximately a dozen Hz corresponding to idling vibration.

The electromagnetic actuator 120 is provided on an opposite side to the main liquid chamber 106 having the support member 76 in between. The electromagnetic actuator 120 has substantially a cup-shaped housing 122 in which a coil 124 is housed and fixedly assembled. An upper yoke 126 and a lower yoke 128, each of which has an annular shape and is formed of a strong magnetic material, are fixedly assembled around the coil 124, and thus a magnetic path is provided. A guide sleeve 130 is elastically positioned and mounted to a tubular internal peripheral surface of the upper yoke 126 forming the magnetic path. A sliding armature 132 formed of a strong magnetic material is slidably assembled in the guide sleeve 130.

The sliding armature 132 is provided in an area of a magnetic gap provided between the upper yoke 126 and the lower yoke 128 forming the magnetic path. When electricity is applied to the coil 124, a magnetic force is exerted on the sliding armature 132, which is then driven in the axial direction as being guided by the guide sleeve 130. The sliding armature 132 has substantially a tubular shape as a whole, having an axially penetrating through-hole 134. An external peripheral surface of the sliding armature 132 is slidable along the guide sleeve 130. An internally projecting engagement projection 136 is provided in an axially upper portion of the through-hole 134.

A flange 138 provided to an opening peripheral portion of the housing 122 of the electromagnetic actuator 120 is placed over the mounting plate portion 96 of the annular holding fitting 82 in the support member 76, and then crimped and fixed by the crimping piece 64 to the second mounting member 14 along with the annular holding fitting 82 and the like. Thereby, the electromagnetic actuator 120 is assembled, such that a sliding central axis of the sliding armature 132 substantially corresponds to the central axis of the first mounting member 12 and the second mounting member 14.

The driving axis 86 of the oscillation member 80 is inserted from above to the electromagnetic actuator 120, assembled as above, along the central axis. The driving axis 86 is then inserted through the through-hole 134 of the sliding armature 132. A fastening member 140 having a tubular nut shape is screwed to an end portion of the driving axis 86 inserted to the engagement projection 136, and thereby the sliding armature 132 is supported by the fastening member 140 while being prevented from disengaging from the driving axis 86.

Further, a coil spring 146 is inserted externally to the driving axis 86, and is provided across a space between opposing surfaces of the oscillation member 80 and the sliding armature 132. Specifically, the fastening member 140 is screwed into the driving axis 86, and the coil spring 146 is compressed in the space with the oscillation member 80 via the engagement projection 136 of the sliding armature 132. Thereby, the sliding armature 132 is urged in a disengagement direction from the driving axis 86 by the coil spring 146, and disengageably supported by the fastening member 140. Thus, the sliding armature 132 is axially positioned to the driving axis 86.

Collar members 148 are mounted to both ends of the coil spring 146 in the prevent embodiment, thus reducing wear of the coil spring 146 due to friction with other members. Thereby, the sliding armature 132 and the driving axis 86 are substantially fixedly connected in the axial direction, and a driving force exerted on the sliding armature 132 with application of electricity to the coil 124 is exerted on the oscillation member 80 via the driving axis 86.

A through-hole 152 is providing penetrating a middle of a bottom wall portion of the housing 122 of the electromagnetic actuator 120. The lower yoke 128 is exposed externally through the through-hole 152, the lower yoke 128 being positioned facing the sliding armature 132 and exerting the magnetic force. The lower yoke 128 has a thick mound-shaped middle projection 154 in a middle portion. The middle projection 154 is inserted to the guide sleeve 130 from below.

The lower yoke 128 is magnetically connected to the housing 122 and the upper yoke 126, along with which the lower yoke 128 forms an annular magnetic path extending along a periphery of the coil 124. A magnetic gap is provided to the magnetic path in a central hole of the coil 124, between the upper yoke 126 and the lower yoke 128. The sliding armature 132 is provided to a position corresponding to the magnetic gap. The sliding armature 132 is provided on an internal peripheral side having the guide sleeve 130 in between with the upper yoke 126, and positioned above the lower yoke 128 having a predetermined distance.

Thereby, when electricity is applied to the coil 124 wound in the circumferential direction, opposing magnetic poles are generated on opposing surfaces of the upper yoke 126 and the lower yoke 128 forming the magnetic gap. The driving force in a direction of minimum magnetic resistance, specifically the driving force in the axial direction toward the lower yoke 128, is exerted on the sliding armature 132 provided to the magnetic gap.

The driving force in the axial direction exerted on the sliding armature 132 is transferred to the oscillation member 80 via the driving axis 86 positioned in the axial direction relative to the sliding armature 132. Thus, the oscillation member 80 is reciprocally displaced in the axial direction, and then an oscillation force is exerted to the excitation chamber 110 having the wall portion partially formed by the oscillation member 80.

The driving axis 86 and the sliding armature 132 are fixed with the fastening member 140, and then the central hole of the annular lower yoke 128 is covered by a covering member 156. The covering member 156 has substantially a circular plate shape, and has a structure in which a first surface of a metal plate is coated by a rubber layer over substantially an entire surface. The covering member 156 is fitted to the central hole of the lower yoke 128. A C-shaped stop ring is fitted from outside of the covering member 156 to the central hole of the lower yoke 128, and engaged and mounted thereto. Thus, the central hole of the lower yoke 128 is covered by the covering member 156.

The covering member 156 is mounted to the lower yoke 128 as described above, and thus a middle portion of the covering member 156 is positioned facing a lower end surface of the driving axis 86 having a predetermined distance in between in the downward axial direction. Thereby, when an end of the driving axis 86 contacts with the covering member 156 via the rubber layer, in a case such as where a large vibration load is input between the first mounting member 12 and the second mounting member 14, and an excessive pressure is generated in the pressure receiving chamber 108, a displacement amount of the oscillation member 80 integrally provided with the driving axis 86 is restricted in a shock-absorbing manner.

A tubular bracket 158 is further inserted externally to the electromagnetic actuator 120 of the engine mount 10 having the above structure. The tubular bracket 158 has a flange-shaped portion 160 in an upper end opening portion. The flange-shaped portion 160 is crimped and fixed to the flexible diaphragm outer tubular fitting 24 by the crimping piece 64, along with the flange-shaped portion 40 of the main rubber outer tubular fitting 22, the mounting plate portion 96 of the annular holding fitting 82, and the flange 138 of the housing 122. A mounting plate portion 162 is provided to a lower end opening portion of the tubular bracket 158. A plurality of attachment holes (not shown in the drawing) are provided to the mounting plate portion 162.

The mounting plate member 54 of the first attachment portion 12 is mounted to a power unit with a mounting bolt inserted through the bolt though-hole 56, and the second mounting member 14 is mounted to a vehicle body with a mounting bolt via the tubular bracket 158. Thus, the engine mount 10 is mounted between the power unit and the body (not shown in the drawing).

When a low-frequency large amplitude vibration corresponding to an engine shake is input while the vehicle is in a running condition, a fluid flow is generated between the pressure receiving chamber 108 and the equilibrium chamber 112 through the first orifice passage 118, based on a relative pressure difference between the chambers 108 and 112. Thus, an anti-vibration effect (vibration damping effect) is exercised based on the flow effect, including resonance of the fluid, and then the input vibration is damped.

When a vibration in a middle frequency range, such as an idling vibration input at stop, is input, the first orifice passage 118 tuned to a lower frequency than the input vibration frequency is substantially blocked due to anti-resonance. Thus, the pressure in the pressure receiving chamber 108 is increased, and the vibration isolation performance is deteriorated since the dynamic spring property becomes significantly high.

In order to avoid deterioration in the anti-vibration performance due to the high dynamic spring property, the engine mount 10 is provided with a shot circuit hole 164 short-circuiting the pressure receiving chamber 108 and the equilibrium chamber 112. The shot circuit hole 164 is a small-diameter through-hole provided to the peripheral wall portion of the pressure receiving chamber 108 and extending in a diameter direction. The shot circuit hole 164 has a first end portion open to the pressure receiving chamber 108 and a second end portion open to an end portion of the first orifice passage 118 on the equilibrium chamber 112 side. Thus, a short circuit passage 166 is formed by the short circuit hole 164 and a portion of the first orifice passage 118, the short circuit passage 166 mutually connecting the pressure receiving chamber 108 and the equilibrium chamber 112. The short circuit hole 164 is positioned in a same circumferential direction, or on a same-cross sectional surface, as the second connecting hole 116, which is the opening portion of the first orifice passage 118 on the equilibrium chamber 112 side. The short circuit hole 164 linearly extends in the diameter direction, and is connected substantially orthogonal to the first orifice passage 118 extending in the circumferential direction.

Further, the short circuit passage 166 has a ratio (a₁/l₁) of a passage cross-sectional area (a₁) and a passage length (l₁) greater than a ratio (A₁/L₁) of a passage cross-sectional area (A₁) and a passage length (L₁) of the first orifice passage 118 (A₁/L₁<a₁/l₁). Thus, a resonance frequency (tuned frequency) of the fluid flowing through the short circuit passage 166 is set to a higher frequency than the tuned frequency of the first orifice passage 118. Thereby, even when the middle frequency vibration is input when the first orifice passage 118 is substantially blocked due to anti-resonance, the pressure receiving chamber 108 and the equilibrium chamber 112 are held connected by the short circuit passage 166.

Since the short circuit passage 166 as described above is provided, the pressure in the pressure receiving chamber 108 is transferred to the equilibrium chamber 112 through the short circuit passage 166, when the vibration in the middle frequency range corresponding to the idling vibration is input. A pressure change in the pressure receiving chamber 108 is then reduced, and the intended anti-vibration effect (vibration isolation effect) is exhibited since a sudden high dynamic spring property is prevented.

Particularly in the engine mount 10, the ratio (a₁/l₁) of the passage cross-sectional area (a₁) and the passage length (l₁) of the short circuit passage 166 is set relative to the ratio (A₁/L₁) of the passage cross-sectional area (A₁) and the passage length (L₁) of the first orifice passage 118, such that a numerical range of A₁/L₁<a₁/l₁ is met. Thus, a resonance frequency of the fluid flowing through the short circuit passage 166 is set higher than a resonance frequency of the fluid flowing through the first orifice passage 118. Accordingly, even when the idling vibration is input when the first orifice passage 118 is substantially blocked due to anti-resonance, the short circuit passage 166 is held connected, and pressure fluctuation in the pressure receiving chamber 108 is reduced. Consequently, significant deterioration of the anti-vibration performance stemming from anti-resonance of the first orifice passage 118 is prevented, and thus the anti-vibration performance can be enhanced.

The effect is also demonstrated in a graph shown in FIG. 3. Specifically, a spring property of the engine mount 10 represented by a solid line in the graph of FIG. 3 (embodiment) has no sudden change in an absolute spring constant in a frequency range of a dozen Hz caused by anti-resonance of the first orifice passage 118, compared with a spring property of an engine mount having a conventional structure represented by a broken line in the graph (comparative example). As described above, the engine mount 10 exhibits a low dynamic spring effect extremely effectively in a range of approximately 15 Hz to 20 Hz, and thus remarkably enhances the anti-vibration performance. In addition, the spring property change is prevented in the range of 15 Hz to 20 Hz, and the absolute spring constant is substantially constant. The spring property shown in the graph of FIG. 3 is a property when a small amplitude vibration is input having an amplitude of 0.1 mm. In both the embodiment and the comparative example, the results are based on measurement when no pressure control is performed on the pressure receiving chamber 108 by the electromagnetic actuator 120.

For the middle frequency vibration of approximately a dozen Hz corresponding to the idling vibration, the pressure in the pressure receiving chamber 108 is actively controlled via the excitation chamber 110, since the oscillation member 80 is vibrated and displaced by the electromagnetic actuator 120. Thus, the active vibration isolation effect is exerted. In the engine mount 10, the active anti-vibration effect is stabilized by the oscillation force of the electromagnetic actuator 120, and thus the anti-vibration performance can further be enhanced.

When a frequency of input vibration changes in such a short time that control of the electromagnetic actuator cannot follow the change in a general active engine mount, the active anti-vibration effect exerted by change in the absolute spring constant is destabilized. Thus, in a frequency range in which a change amount of the absolute spring constant is large relative to the frequency change, due to anti-resonance of the first orifice passage and the like, the active anti-vibration effect is not sufficiently exerted, and thus the anti-vibration performance may be deteriorated.

In the engine mount 10 of the present embodiment, the change amount of the absolute spring constant relative to the frequency change is reduced due to the fluid flow through the short circuit passage 166. Thus, even when the frequency of input vibration changes at such a short time that the active control cannot follow the change, a change in the active anti-vibration property can be reduced. Accordingly, the present invention stably achieves an effective active anti-vibration effect in an engine mount in which the frequency of input vibration varies.

Further, compared to the passage cross-sectional area of the first orifice passage 118 (A₁), the passage cross-sectional area of the short circuit passage 166 (a₁) is set sufficiently smaller (a₁<A₁). Relative to the ratio of the passage length and the passage cross-sectional area of the first orifice passage 118 (A₁/L₁), the ratio of the passage length and the passage cross-sectional area of the short circuit passage 166 (a₁/l₁) is set within a range of A₁/L₁<a₁/l₁<42A₁/L₁. Thus, the oscillation force exerted on the pressure receiving chamber 108 due to vibration and displacement of the oscillation member 80, can reduce a liquid pressure in the pressure receiving chamber 108 being transferred to and absorbed in the equilibrium chamber 112 through the short circuit passage 166. Accordingly, the pressure in the pressure receiving chamber 108 is effectively controlled by the electromagnetic actuator 120, and thus the active anti-vibration effect (vibration isolation effect) is effectively exerted.

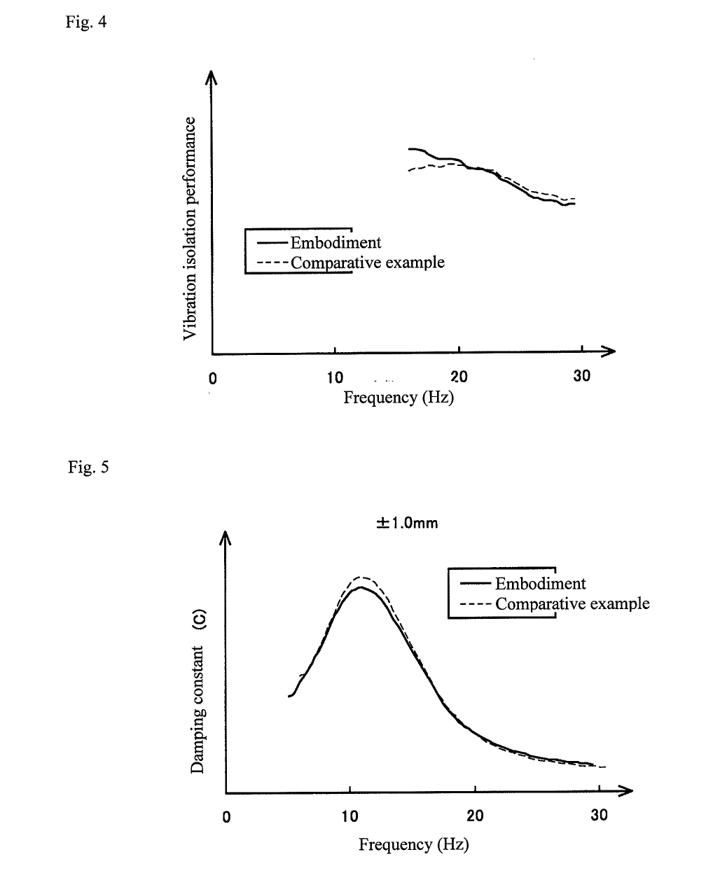

The improvement in the active vibration isolation performance in the engine mount 10 is also demonstrated in a graph shown in FIG. 4. Specifically, it is demonstrated that the vibration isolation performance of the engine mount 10 (embodiment) represented by a solid line in the graph of FIG. 4, to the middle frequency vibration of approximately 15 Hz to 20 Hz, to which the active anti-vibration effect should be exerted, is superior to the vibration isolation performance of an engine mount having a conventional structure (comparative example) represented by a broken line in the graph.

Generally, when a short circuit passage having a greater ratio of the passage length and the passage cross-sectional area than that of the first orifice passage is provided connectedly all the time, the liquid pressure in the pressure receiving chamber is transferred to the equilibrium chamber through the short circuit passage having a low flow resistance, even when a low frequency range vibration is input to which the first orifice passage is tuned, and thus the damping performance may be deteriorated.

In the engine mount 10, compared to the passage cross-sectional area of the first orifice passage 118 (A₁), the passage cross-sectional area of the short circuit passage 166 (a₁) is set sufficiently small (a₁<A₁). Thereby, the fluid flow through the short circuit passage 166 is limited when the low frequency large amplitude vibration is input. Thus, when the low frequency large amplitude vibration is input corresponding to an engine shake to which the first orifice passage 118 is tuned, the fluid flow amount though the first orifice passage 118 is sufficiently secured, and the anti-vibration effect based on the fluid flow effect is effectively exerted.

In addition, it is preferable that the ratio (a₁/l₁) of the passage cross-sectional area and the passage length of the short circuit passage 166 be set smaller than 42 times the ratio (A₁/L₁) of the passage cross-sectional area and the passage length of the first orifice passage 118 (a₁/l₁<42A₁/L₁). When the ratio of the passage cross-sectional area and the passage length of the short circuit passage 166 is set within the numerical range, a difference of flow resistance is limited between the short circuit passage 166 and the first orifice passage 118. Accordingly, when the vibration is input at the frequency range to which the first orifice passage 118 is tuned, the pressure of the pressure receiving chamber 108 transferred to the equilibrium chamber 112 through the short circuit passage 166 is reduced, and thus the fluid flow is effectively generated through the first orifice passage 118.

The effect is also demonstrated in a graph of FIG. 5 illustrating a change in damping performance to frequency. Specifically, it is demonstrated that, with respect to the damping property of the engine mount 10 represented by a solid line in the graph of FIG. 5, the damping performance in the low frequency range of around 10 Hz is maintained at a sufficiently high level. The damping property shown in FIG. 5 is a property when a large amplitude vibration is input having an amplitude of 1.0 mm. In both the embodiment and the comparative example, the results are based on measurement when no pressure control is performed on the pressure receiving chamber 108 by the electromagnetic actuator 120.

As described above, the passage cross-sectional area and the passage length of the short circuit passage 166 are limited to a specific range in the engine mount 10, and thereby all anti-vibration effects are effectively attained, and further improvement in the anti-vibration performance can be achieved, the anti-vibration effects including the anti-vibration effect against the idling vibration achieved by providing the short circuit passage 166, the anti-vibration effect against the engine shake achieved by the first orifice passage 118, and the anti-vibration effect achieved by active pressure control of the pressure receiving chamber 108. Even when the input vibration frequency varies, in particular, the active vibration isolation effect is stably exerted. Even when vibration of a plurality of types of slightly different frequencies is input, the active vibration isolation effect is effectively exerted on any vibration of the plurality of types.

In addition, the second orifice passage 119 is formed by the orifice through-hole 102 connecting the pressure receiving chamber 108 and the equilibrium chamber 110 in the present embodiment. When the middle frequency vibration is input corresponding to the idling vibration, the active anti-vibration effect is also exerted based on the flow effect, such as resonance of the flowing fluid through the second orifice passage 119.

The embodiment of the present invention was explained in details above, but the present invention is not limited by specifics of the description. In the present embodiment, for instance, the structure is shown in which the equilibrium chamber 112 surrounds the external peripheral side of the main rubber elastic body 16. The present invention is also applicable to a fluid-filled active engine mount having a structure in which a fluid-filled area is provided between a main rubber elastic body and a flexible diaphragm which are provided axially opposite to each other, and a pressure receiving chamber and an equilibrium chamber are provided when the fluid-filled area is partitioned by the partition member, as disclosed in Japanese Patent Laid-open Publication No. 2005-155855.

The short circuit passage may not be necessarily formed by partially using the first orifice passage. Specifically, the short circuit passage may have an independent structure from the orifice passage, such as, for example, a separate structure by penetrating the main rubber elastic body. Further, for instance, the short circuit hole connecting the equilibrium chamber and the second orifice passage may be provided penetrating the wall portion of the second orifice passage, such that the short circuit passage is formed by partially using the short circuit hole and the second orifice passage.

Further, the orifice through-hole 102 forms the second orifice passage 119 tuned to the middle frequency in the present embodiment. The orifice through-hole 102, however, may be used as a filter orifice. Specifically, the pressure receiving chamber 108 and the excitation chamber 110 may be connected through the orifice through-hole 102, for instance, so that a high frequency component not corresponding to input vibration can be prevented from transferring to the pressure receiving chamber 108 when vibration generates the pressure change in the excitation chamber 110.

The short circuit passage does not necessarily have one flow passage, but may have a plurality of flow passages.

An application range of the present invention is not limited to a fluid-filled active engine mount for vehicles, but may include a fluid-filled active engine mount for railcars, industrial cars, and motorcycles, for example.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

1. A fluid-filled active engine mount comprising:
a pressure receiving chamber having a wall portion partially formed of a main rubber elastic body connecting a first mounting member and a second mounting member; and
an equilibrium chamber having a wall portion partially formed of a flexible diaphragm, wherein
incompressible fluid is filled in the pressure receiving chamber and the equilibrium chamber;
a first orifice passage is provided mutually connecting the pressure receiving chamber and the equilibrium chamber;
the first orifice passage is tuned to a low frequency corresponding to an engine shake;
an oscillation member is provided exerting an oscillation force to the pressure receiving chamber;
an electromagnetic actuator is provided exerting a driving force on the oscillation member,
the oscillation member is excited and displaced by the electromagnetic actuator, and thereby a pressure in the pressure receiving chamber is actively controlled;
a short circuit passage is provided connecting the pressure receiving chamber to the equilibrium chamber;
a ratio of a passage cross-sectional area and a passage length of the short circuit passage is provided greater than a ratio of a passage cross-sectional area and a passage length of the first orifice passage; and
the passage cross-sectional area of the short circuit passage is provided smaller than the passage cross-sectional area of the first orifice passage.

2. The fluid-filled active engine mount according to claim 1, further comprising:
an excitation chamber having a wall portion partially formed of the oscillation member, wherein
incompressible fluid is filled in the excitation chamber;
a second orifice passage is provided connecting the excitation chamber to the pressure receiving chamber; and
the second orifice passage is tuned to an idling vibration at a higher frequency than that in the first orifice passage.

3. The fluid-filled active engine mount according to claim 1, wherein the short circuit passage comprises a short circuit hole penetrating a portion of the wall portion of the first orifice passage.

4. The fluid-filled active engine mount according to claim 3, wherein the short circuit hole is provided connecting the pressure receiving chamber and the first orifice passage and is provided at a same circumferential position as an opening portion of the first orifice passage on the equilibrium chamber side.

5. The fluid-filled active engine mount according to claim 3, wherein the short circuit hole is provided extending in an orthogonal direction to a passage length direction of the first orifice passage.

6. The fluid-filled active engine mount according to claim 2, wherein the short circuit passage comprises a short circuit hole penetrating a portion of the wall portion of the first orifice passage.

7. The fluid-filled active engine mount according to claim 6, wherein the short circuit hole is provided connecting the pressure receiving chamber and the first orifice passage and is provided at a same circumferential position as an opening portion of the first orifice passage on the equilibrium chamber side.

8. The fluid-filled active engine mount according to claim 4, wherein the short circuit hole is provided extending in an orthogonal direction to a passage length direction of the first orifice passage.

9. The fluid-filled active engine mount according to claim 6, wherein the short circuit hole is provided extending in an orthogonal direction to a passage length direction of the first orifice passage.

10. The fluid-filled active engine mount according to claim 7, wherein the short circuit hole is provided extending in an orthogonal direction to a passage length direction of the first orifice passage.
